(19) United States
(12) Patent Application Publication
(10) Pub. No.: US 2020/0364701 A1
(43) Pub. Date: Nov. 19, 2020

(54) INFORMATION RELAY DEVICE, TOLL COLLECTION MACHINE, MEDIUM, ONBOARD DEVICE, AND ROADSIDE DEVICE

(71) Applicant: MITSUBISHI HEAVY INDUSTRIES MACHINERY SYSTEMS, LTD., Hyogo (JP)

(72) Inventors: Yoshifumi HAYAKAWA, Tokyo (JP); Yamato ITO, Tokyo (JP)

(21) Appl. No.: 16/758,078

(22) PCT Filed: Oct. 31, 2017
(86) PCT No.: PCT/JP2017/039437

§ 371 Date: Apr. 22, 2020

(51) Int. Cl. G06Q 20/38; G06Q 20/14

(52) U.S. Cl. CPC G06Q 20/382; G06Q 2240/00; G06Q 20/145

(57) ABSTRACT

An information relay device includes a reception unit configured to receive encrypted information in which account information recorded in a medium provided to a user of a toll road and used to identify a payment means of the user and fee information including the usage fee for the user calculated in a toll booth on the toll road are encrypted, a security communication unit provided from the service provider and configured to decrypt the encrypted information, and a payment request unit configured to transmit payment request information including the account information decrypted from the encrypted information and the fee information to a payer who provides the payment means identified from the account information.

### TECHNICAL FIELD

The present invention relates to an information relay device, a toll collection machine, a medium, an onboard device, and a roadside device.

### BACKGROUND ART

As a system for collecting a usage fee of a toll road, an electronic toll collection system (ETC) (registered trademark) (also referred to as an “automated toll collection system”) in which a toll collection process is performed by performing wireless communication between an onboard device mounted in a vehicle and a roadside device installed in a toll booth on the toll road has become widespread.

In the electronic toll collection system, the roadside device installed in the toll booth acquires various types of information necessary for the toll collection process such as card information (a card number, an expiration date, and the like) recorded in an IC card (such as an “ETC card”) issued to the user in advance and passage history information (a number of the toll booth through which a user has passed, a passage time, and the like) and performs a process of collecting a usage fee for a vehicle on the basis of the card information and the usage fee according to the passage history information. At this time, in the electronic toll collection system, a card issuer (a credit card company or the like) issuing an IC card pays a usage fee to a business operator of a toll road on behalf of the user and the usage fee is collected according to deferred payment in which the usage fee is later deducted from a bank account associated with the card by the card issuer (for example, see Non-Patent Document 1).

### CITATION LIST

### Non-Patent Literature

[Non-Patent Document 1]

“2016 Edition ETC Handbook,” [online], General Foundation Corporation, ITS Technology Enhancement Association, p. 24, Internet <URL:https://www.its-tea.or.jp/library/pdf/h28_ETC_binran_web.pdf>

### SUMMARY OF INVENTION

### Technical Problem

In recent years, a financial service mechanism called FinTech that uses technologies such as information and communication technology (ICT) and blockchain has attracted attention. As an aspect of the service of FinTech, for example, a payment service in which various types of payment means such as electronic money, vouchers, points, virtual currency, a debit card (a payment card associated with a deposit account), and a credit card are available is considered.

As described above, in the conventional electronic toll collection system, the user cannot pay the usage fee using a payment means other than a payment means designated by the card issuer (deferred payment such as credit card payment). Thus, there has been a demand for the introduction of a payment service in which various types of payment means are available in a toll collection system for a toll road.

### Solution to Problem

In order to solve the above-described problems, the present invention adopts the following means.

According to a first aspect of the present invention, there is provided an information relay device (30) provided in a service provider for performing a process of paying a usage fee of a toll road, the information relay device (30) including: a reception unit (301) configured to receive encrypted information in which account information (D1) recorded in a medium (11) provided to a user of the toll road and used to identify a payment means of the user and fee information (D3) including the usage fee for the user calculated in a toll booth on the toll road are encrypted; a security communication unit (302) provided from the service provider and configured to decrypt the encrypted information; and a payment request unit (303) configured to transmit payment request information including the account information decrypted from the encrypted information and the fee information to a payer who provides the payment means identified from the account information.

Thereby, the information relay device can appropriately transmit a payment request to each of the payers providing the payment means on the basis of the account information even if a different payment means is designated for each user. Thereby, the information relay device can provide the user with a payment service using various types of payment means as well as a credit card.

According to a second aspect of the present invention, in the information relay device (30) according to the first aspect, the payer is a bank and the payment means is a bank account.

Because high-level security is required for a network for accessing a bank account, a conventional system does not have a mechanism for performing payment by making a direct connection from a toll booth on the toll road to the bank account. However, as described above, the information relay device for performing encryption and decryption through the security communication unit can relay information between the toll booth and the bank and therefore issue a payment request for the usage fee of the toll road to the bank that is the payer without lowering the security level of the network for accessing the bank account. Thereby, the information relay device can provide the user of the toll road with a payment service for immediately paying a usage fee from the bank account of the user.

According to a third aspect of the present invention, the information relay device (30) according to the first or second aspect further includes a payment information notification unit (305) configured to notify that a balance is insufficient when the balance in the payment means is less than the usage fee.

Thereby, the information relay device can immediately notify the user that the balance in the payment means is insufficient.

According to a fourth aspect of the present invention, there is provided a toll collection machine (21) including: a reception unit (210) configured to receive encrypted information in which account information (D1) recorded in a medium (11) provided to a user and used to identify a payment means of the user is encrypted; a fee information generation unit (211) configured to generate fee information (D3) including a usage fee according to a use form of a toll road for the user; a security communication unit (212) provided from the service provider and configured to generate encrypted information in which the account information (D1) and the fee information (D3) are encrypted; and a transmission unit (213) configured to transmit the encrypted information to the service provider.

Thereby, the toll collection machine can request payment according to the account information by transmitting the account information and the fee information to the service provider even if a different payment means is designated for each user. Thereby, the toll collection machine is not limited to a credit card and can be compatible with a payment service using various types of payment means.

According to a fifth aspect of the present invention, the toll collection machine (21) according to the fourth aspect further includes an insufficient balance notification unit (215) configured to notify that a balance is insufficient when the balance in the payment means is less than the usage fee.

Thereby, the toll collection machine can immediately notify the user that the balance in the payment means is insufficient.

According to a sixth aspect of the present invention, there is provided a medium (11) provided to a user of the toll road, the medium (11) including: an account information acquisition unit (110) configured to acquire account information (D1) prestored in a storage medium (111) and used to identify a payment means of the user; a fee information acquisition unit (114) configured to acquire fee information (D3) including a usage fee for the user calculated in a toll booth on the toll road; a security communication unit (112) provided from the service provider and configured to generate encrypted information in which the account information (D1) and the fee information (D3) are encrypted; and a transmission unit (113) configured to transmit the encrypted information to the service provider.

Thereby, the medium can request the service provider to perform payment according to the payment means desired by the user by transmitting the account information prestored in the storage medium and the fee information acquired from the toll booth to the service provider. Thereby, the medium is not limited to a credit card and can be compatible with a payment service using various types of payment means.

According to a seventh aspect of the present invention, in the medium (11) according to the sixth aspect, the fee information acquisition unit (114) is configured to acquire the fee information (D3) by performing wireless communication with an onboard device (10) mounted in a vehicle.

According to an eighth aspect of the present invention, there is provided an onboard device (10) including: a fee information acquisition unit (104) configured to acquire fee information (D3) including a usage fee of a toll road calculated in a toll booth on the toll road; an account information acquisition unit (100) configured to acquire account information (D1) prestored in a storage medium (111) of a medium (11) provided to a user of the toll road and used to identify a payment means of the user when the fee information (D3) has been acquired; a security communication unit (102) provided from the service provider and configured to generate encrypted information in which the account information (D1) and the fee information (D3) are encrypted; and a transmission unit (103) configured to transmit the encrypted information to the service provider.

Thereby, the onboard device can request the service provider to perform payment according to a payment means desired by the user by transmitting the account information prestored in the storage medium of the medium and the fee information acquired from the toll booth to the service provider. Thereby, the onboard device is not limited to a credit card and can be compatible with a payment service using various types of payment means.

According to a ninth aspect of the present invention, there is provided a roadside device (20) including: a reception unit (200) configured to receive encrypted information in which account information (D1) recorded in a medium (11) provided to a user of a toll road and used to identify a payment means of the user is encrypted; a fee information generation unit (201) configured to generate fee information (D3) including a usage fee according to a use form of the toll road for the user; a security communication unit (202) provided from a service provider and configured to generate encrypted information in which the account information (D1) and the fee information (D3) are encrypted; and a transmission unit (203) configured to transmit the encrypted information to the service provider.

Thereby, the roadside device can request payment according to the account information by transmitting the account information and the fee information to the service provider even if a different payment means is designated for each user. Thereby, the roadside device is not limited to a credit card and can be compatible with a payment service using various types of payment means.

### Advantageous Effects of Invention

According to the information relay device, the toll collection machine, the medium, the onboard device, and the roadside device described above, it is possible to provide a payment service in which a plurality of types of payment means are available.

### BRIEF DESCRIPTION OF DRAWINGS

FIG. 1 is a diagram schematically showing a toll collection system according to a first embodiment of the present invention.

FIG. 2 is a diagram showing a functional configuration of the toll collection system according to the first embodiment of the present invention.

FIG. 3 is a flowchart showing an example of a process in a medium according to the first embodiment of the present invention.

FIG. 4 is a diagram showing an example of account information according to the first embodiment of the present invention.

FIG. 5 is a diagram showing an example of medium information according to the first embodiment of the present invention.

FIG. 6 is a flowchart showing an example of a process in the toll collection machine according to the first embodiment of the present invention.

FIG. 7 is a diagram showing an example of fee information according to the first embodiment of the present invention.

FIG. 8 is a diagram showing an example of bill information according to the first embodiment of the present invention.

FIG. 9 is a diagram showing an example of payment information according to the first embodiment of the present invention.

FIG. 10 is a flowchart showing an example of a process in an information relay device according to the first embodiment of the present invention.

FIG. 11 is a diagram showing an example of payment request information according to the first embodiment of the present invention.

FIG. 12 is a diagram showing a functional configuration of a toll collection system according to a second embodiment of the present invention.

FIG. 13 is a diagram showing a functional configuration of a toll collection system according to a third embodiment of the present invention.

FIG. 14 is a diagram showing a functional configuration of a toll collection system according to a fourth embodiment of the present invention.

FIG. 15 is a diagram showing a functional configuration of a toll collection system according to a fifth embodiment of the present invention.

### DESCRIPTION OF EMBODIMENTS

### First Embodiment

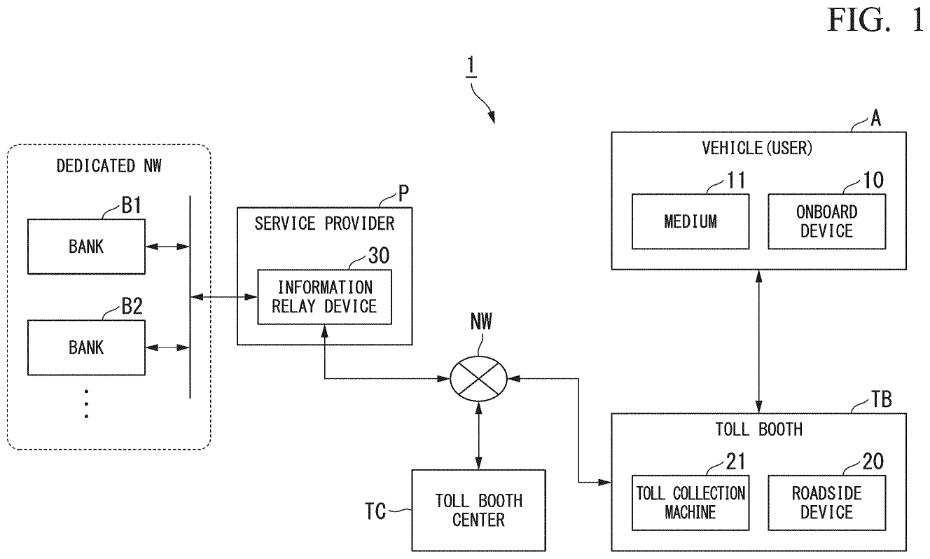

Hereinafter, a toll collection system 1 according to a first embodiment of the present invention will be described with reference to FIGS. 1 to 11.

### (Overall Configuration of Toll Collection System)

FIG. 1 is a diagram schematically showing a toll collection system according to the first embodiment of the present invention.

As shown in FIG. 1, the toll collection system 1 includes a vehicle A that travels on a toll road, a toll booth TB on the toll road, and a service provider P for providing a payment service for a usage fee of the toll road.

The toll booth TB is, for example, an exit toll booth provided at an exit of the toll road and includes various types of facilities for collecting a usage fee of the toll road from the vehicle A that travels on the toll road. Also, in another embodiment, the toll booth TB may be an entrance toll booth provided at an entrance of the toll road.

The toll booth TB includes a roadside device 20 and a toll collection machine 21 as the facilities for collecting the usage fee.

The roadside device 20 performs wireless communication with the onboard device 10 mounted in the vehicle A and thus performs a process of collecting the usage fee for the vehicle A entering a communication area (also referred to as a “toll collection process”). At this time, the roadside device 20 acquires a vehicle type classification of the vehicle A and a travel distance on the toll road from the onboard device 10 and collects the usage fee from the vehicle A according to the vehicle type classification and the travel distance.

The toll collection machine 21 is an automated toll collection machine that accepts an operation of a driver or the like of the vehicle A (hereinafter referred to as a “user”) and automatedly performs the toll collection process. Also, in another embodiment, the toll collection machine 21 may be a toll collection machine that accepts an operation of a toll collector stationed in a manned booth which is the toll booth TB and performs the toll collection process.

A toll booth center TC is connected to a plurality of toll booths TB via a network (NW) such as the Internet and collects processing result data of the toll collection process at each toll booth TB. The processing result data includes, for example, information (an onboard device ID, a user ID, or the like) for identifying the user (the vehicle A) on the toll road, entrance information for identifying an entrance toll booth used by the user, exit information for identifying the exit toll booth used by the user, and a usage fee charged to the user.

The service provider P is a company that performs a payment process (a payment service) in which a usage fee of the toll road is paid using the FinTech mechanism without the use of cash.

The medium 11 in which account information for identifying the payment means of the user is recorded is provided to the user. Also, the service provider P may provide the medium 11 to the user who has previously made a contract for using the payment service. The payment means is, for example, payment (remittance) using an account (hereinafter referred to as a “bank account”) of a financial institution that handles savings and deposits such as a bank, a credit card, or a social networking service (SNS). In the account information, information such as a “bank account ID and a PIN,” a “credit card number and an expiration date,” and an “SNS account ID and a PIN” for identifying these payment means is recorded.

The service provider P includes an information relay device 30 configured to acquire the account information recorded in the medium 11 and fee information including the usage fee and perform a process of paying the usage fee when the toll collection process is performed in the toll booth TB. The information relay device 30 identifies the payer that provides the payment means of the user with reference to the account information and requests the payer to pay the usage fee. The payer is a company that performs payment of the usage fee on behalf of the user from the user's payment means, and is, for example, a bank, a credit card company, an SNS operating company, or the like. In the present embodiment, as shown in FIG. 1, an aspect in which the payer is a bank (a bank B1, a bank B2, or the like) will be described as an example. In response to a request from the service provider P, the bank that is the payer pays the usage fee from the user's payment means (bank account) identified from the account information. Also, the payer and the service provider P (the information relay device 30) are connected so that they can perform communication via a dedicated network (NW) to which high security is applied.

Also, although an example in which the toll collection system 1 has only one service provider P is shown in FIG. 1, the present invention is not limited thereto. In another embodiment, the toll collection system 1 may have a plurality of service providers P. Also, although an aspect in which the service provider P is a company different from the payer will be described as an example in the present embodiment, the present invention is not limited thereto. In another embodiment, the service provider P and the payer may be the same company.

### (Functional Configuration of Toll Collection System)

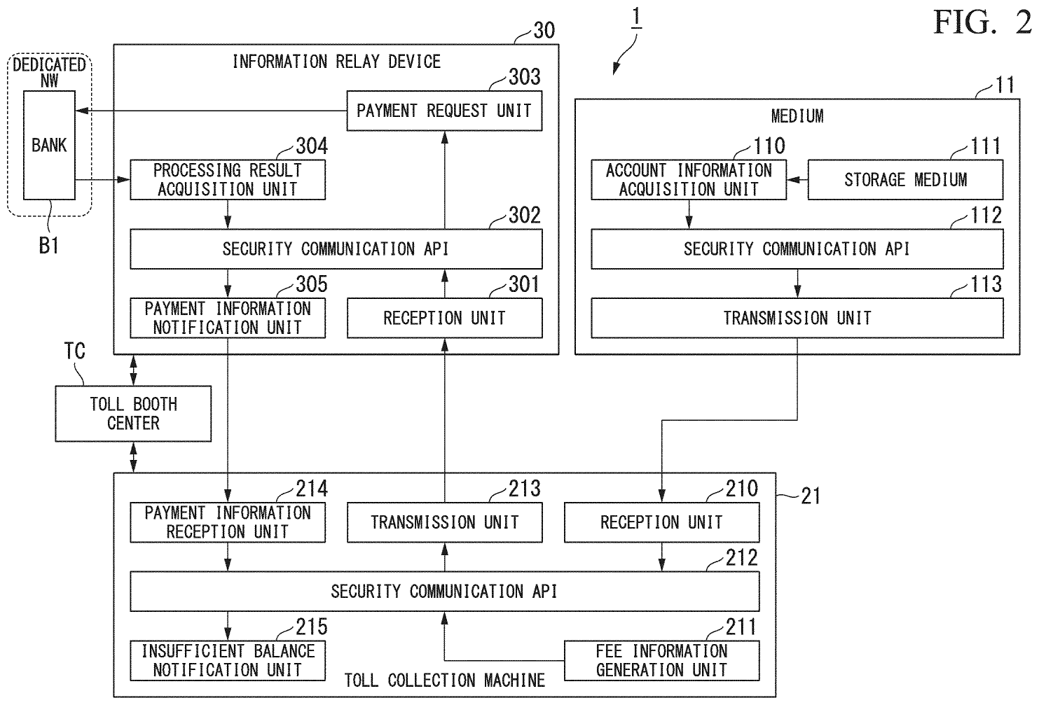

FIG. 2 is a diagram showing a functional configuration of the toll collection system according to the first embodiment of the present invention.

In the present embodiment, an aspect in which the toll collection machine 21 installed in the toll booth TB acquires account information necessary for a process of collecting a usage fee of the toll road from the medium 11 possessed by the user and transmits various types of information related to the payment of the usage fee to the information relay device 30 will be described.

The medium 11 is an IC card, a mobile terminal (a smartphone, a tablet, or the like), a computer, or the like provided to the user.

As shown in FIG. 2, the medium 11 includes an account information acquisition unit 110, a storage medium 111, a security communication application programming interface (API) 112 (a security communication unit), and a transmission unit 113.

The account information acquisition unit 110 acquires “account information D1 (FIG. 4)” of the user prestored in the storage medium 111.

The security communication API 112 is an API provided from the service provider P and is a functional unit having a connection function related to a connection to the information relay device 30 provided in the service provider P and a security function of encrypting and decrypting information transmitted and received by the medium 11.

The security communication API 112 generates encrypted information in which the account information D1 acquired by the account information acquisition unit 110 is encrypted.

The transmission unit 113 transmits the encrypted information (the account information D1) encrypted by the security communication API to the toll collection machine 21.

Also, in the present embodiment, it is assumed that the transmission unit 113 transmits the account information D1 to the toll collection machine 21 using short-range wireless communication.

Also, as shown in FIG. 2, the toll collection machine 21 includes a reception unit 210, a fee information generation unit 211, a security communication API 212 (a security communication unit), a transmission unit 213, a payment information reception unit 214, and an insufficient balance notification unit 215.

The reception unit 210 receives the account information D1 from the medium 11.

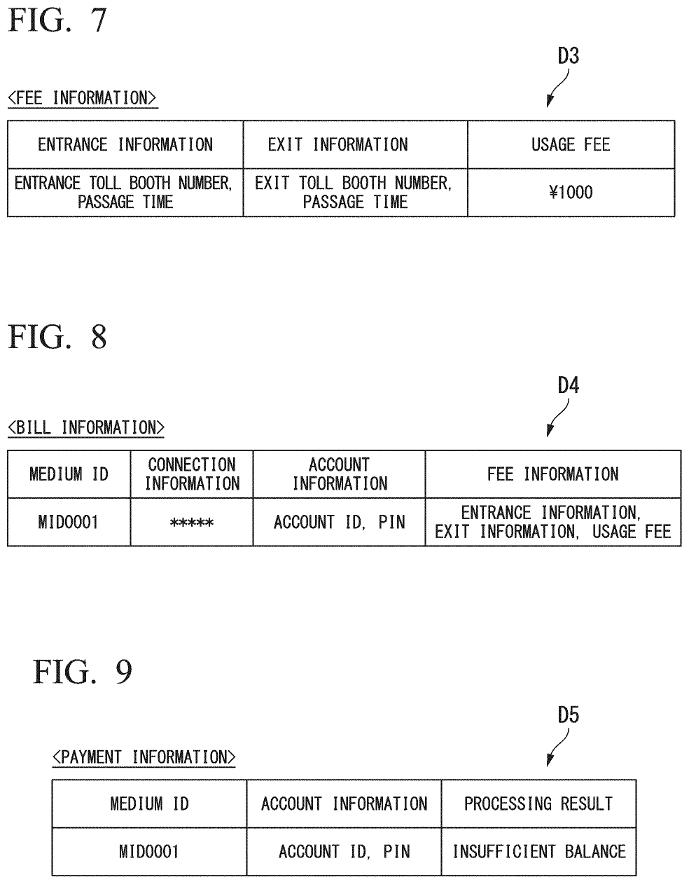

The fee information generation unit 211 generates “fee information D3 (FIG. 7)” including a usage fee according to a use form of the toll road for the user (the vehicle A). Details of the fee information will be described below.

The security communication API 212 is an API provided from the service provider P and is a functional unit having a connection function related to a connection to the information relay device 30 provided in the service provider P and a security function of encrypting and decrypting information transmitted and received by the toll collection machine 21.

The security communication API 212 generates encrypted information (“bill information D4 (FIG. 8)”) in which the “account information D1” received by the reception unit 210 and the “fee information D3” generated by the fee information generation unit 211 are encrypted.

Also, the security communication API 212 performs a process of establishing a connection for transmitting and receiving information to and from the information relay device 30 on the basis of connection information (information indicating a connection destination and a connection method) for connecting to the information relay device 30 incorporated in the API in advance.

When the security communication API 212 establishes a connection with the information relay device 30, the transmission unit 213 transmits the “bill information D4” generated by the security communication API 212 to the information relay device 30.

Also, although an aspect in which the toll collection machine 21 directly transmits the bill information D4 to the information relay device 30 via a network such as the Internet will be described in the present embodiment, the present invention is not limited thereto. In another embodiment, the bill information D4 may be transmitted from the toll collection machine 21 to the information relay device 30 via the toll booth center TC.

The payment information reception unit 214 receives “payment information D5 (FIG. 9)” indicating whether or not the payment from the payment means (the bank account) identified from the account information D1 of the user has succeeded from the information relay device 30. Details of the payment information D5 will be described below.

When the payment information D5 received by the payment information reception unit 214 includes information indicating an “insufficient balance,” the insufficient balance notification unit 215 notifies the user of “insufficient balance information” indicating that the balance in the payment means of the user is insufficient. Also, when the payer is a bank, the balance is a balance in a bank account. Also, the balance is, for example, an available balance when the payer is a credit card company and the balance is, for example, a charge balance in an SNS account when the payer is an SNS operating company.

Also, as shown in FIG. 2, the information relay device 30 includes a reception unit 301, a security communication API 302 (a security communication unit), a payment request unit 303, a processing result acquisition unit 304, and a payment information notification unit 305.

The reception unit 301 receives the “bill information D4 (FIG. 8)” including the account information D1 and the fee information D3 from the toll collection machine 21.

The security communication API 302 is a functional unit having a security function of encrypting and decrypting information transmitted and received by the information relay device 30.

The security communication API 302 decrypts the “bill information D4” using encryption key information of the service provider P incorporated in the API in advance.

The payment request unit 303 requests the payer to pay the usage fee by transmitting “payment request information D6 (FIG. 11)” including the “account information D1” and the “fee information D3” to the payer (a bank B1) providing the payment means (a bank account in the bank B1) identified from the “account information D1” included in the bill information D4 that has been decrypted.

Then, the payer executes a process of paying (transmitting) the usage fee identified from the fee information D3 from the bank account of the user identified from the account information D1 to a payee account (for example, a bank account of the toll booth center TC).

The processing result acquisition unit 304 acquires a processing result related to payment of the usage fee by the payer. The processing result acquisition unit 304 acquires a processing result indicating “payment completion” when the payer has paid the usage fee from the bank account of the user normally. Also, the processing result acquisition unit 304 acquires a processing result indicating an “insufficient balance” when the payment of the usage fee has failed due to the insufficient balance in the bank account of the user.

The payment information notification unit 305 generates “payment information D5 (FIG. 9)” including the “processing result” acquired by the processing result acquisition unit 304 and transmits the payment information D5 to the toll collection machine 21. Details of the payment information D5 will be described below.

### (Process Flow of Medium)

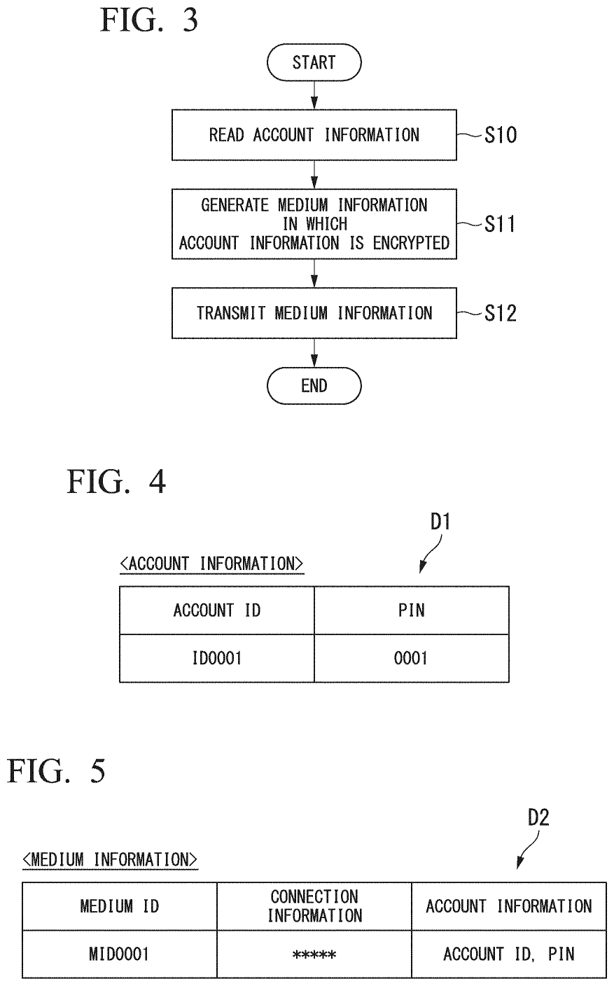

FIG. 3 is a flowchart showing an example of a process in the medium according to the first embodiment of the present invention.

FIG. 4 is a diagram showing an example of account information according to the first embodiment of the present invention.

FIG. 5 is a diagram showing an example of medium information according to the first embodiment of the present invention.

Hereinafter, an example of a process in the medium 11 will be described with reference to FIGS. 3 to 5.

When the vehicle A reaches the toll booth TB, a user such as a driver of the vehicle A operates the toll collection machine 21. Thereby, the toll collection machine 21 starts the toll collection process for the vehicle A. At this time, the toll collection machine 21 requests the medium 11 possessed by the user to transmit the account information D1.

When the request from the toll collection machine 21 is accepted, the account information acquisition unit 110 of the medium 11 acquires the account information D1 (FIG. 4) stored in the storage medium 111 as shown in FIG. 3 (step S10).

For example, it is assumed that the user has designated a payment means for paying the usage fee from the bank account in the bank B1 and has made a contract for using the payment service of the service provider P. In this case, as shown in FIG. 4, in the storage medium 111, an “account ID” and a “PIN” for identifying a bank account possessed by the user in the bank B1 are stored as the account information D1. It is assumed that such account information D1 is prestored in the storage medium 111 of the medium 11 when the user has made the contract for using the payment service of the service provider P.

Next, the security communication API 112 generates encrypted information (“medium information D2 (FIG. 5)”) in which the account information D1 is encrypted using the encryption key information of the service provider P incorporated in the API in advance (step S11).

At this time, as shown in FIG. 5, the security communication API 112 may be configured to generate the medium information D2 obtained by encrypting the “medium ID” for identifying the medium 11 and “connection information (information indicating a connection destination and a connection method)” for connecting to the information relay device 30 incorporated in the API in advance in association with the “account information D1”.

Next, the transmission unit 113 transmits the medium information D2 generated by the security communication API to the toll collection machine 21 (step S12).

Each unit of the medium 11 executes the above-described process every time the toll booth TB accepts a transmission request for the account information D1 from the toll collection machine 21.

### (Process Flow of Toll Collection Machine)

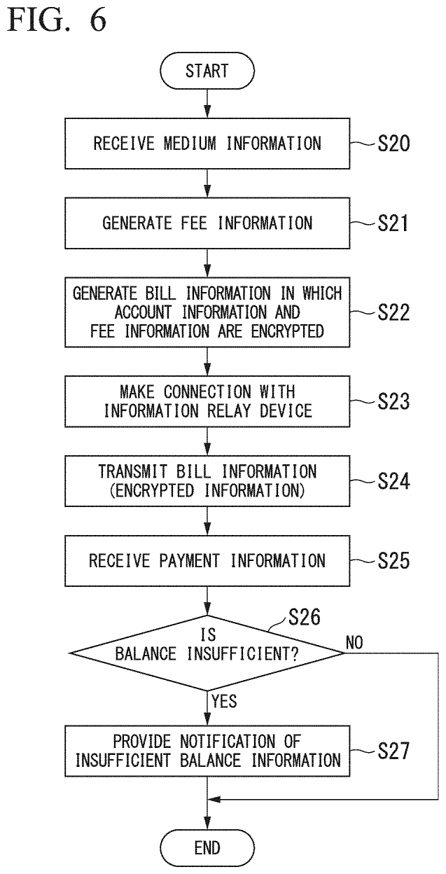

FIG. 6 is a flowchart showing an example of a process in the toll collection machine according to the first embodiment of the present invention.

FIG. 7 is a diagram showing an example of fee information according to the first embodiment of the present invention.

FIG. 8 is a diagram showing an example of bill information according to the first embodiment of the present invention.

Hereinafter, an example of a toll collection process of the toll collection machine 21 will be described with reference to FIGS. 6 to 8.

When the vehicle A reaches the toll booth TB, a user (or a toll collector) such as a driver of the vehicle A operates the toll collection machine 21. Then, the toll collection machine 21 starts a process of collecting the usage fee for the vehicle A (the user).

Specifically, as shown in FIG. 6, the reception unit 210 of the toll collection machine 21 requests the medium 11 to transmit the account information D1 and receives the medium information D2 (FIG. 5) that is encrypted information in which the account information D1 (FIG. 4) is encrypted from the medium 11 (step S20).

Next, the fee information generation unit 211 generates the “fee information D3 (FIG. 7)” including a usage fee according to the use form of the toll road for the user (the vehicle A) (step S21).

As shown in FIG. 7, the fee information D3 includes entrance information (an entrance toll booth number and a passage time) indicating an entrance toll booth through which the vehicle A has entered the toll road and a clock time when the vehicle A has entered the toll road, exit information (an exit toll booth number and a passage time) indicating an exit toll booth (the toll booth TB) through which the vehicle A has left the toll road and a clock time when the vehicle M has left the toll road, and a usage fee for the vehicle A.

The fee information generation unit 211 according to the present embodiment acquires entrance information and a vehicle type classification of the vehicle A input by the user or the toll collector and calculates the usage fee according to a usage distance of the vehicle A to the toll booth TB (the exit toll booth) in which the toll collection machine 21 has been installed and the vehicle type classification of the vehicle A. At this time, the fee information generation unit 211 may calculate the usage fee according to a discount classification (for example, a discount for the disabled) input by the toll collector.

Also, the entrance information is recorded in a toll ticket issued at the entrance toll booth and the entrance information is input to the toll collection machine 21 by inserting the toll ticket into the toll collection machine 21. Also, the vehicle type classification and the discount classification may be input to the toll collection machine 21 by the toll collector or may be recorded on the toll ticket by a vehicle type identification device (not shown) installed in the entrance toll booth. Also, the above-described information may be recorded in the medium 11 instead of on the toll ticket or the toll collection machine 21 may acquire the information from the medium 11 through communication.

The fee information generation unit 211 generates the “fee information D3 (FIG. 7)” in which the entrance information (the entrance toll booth number and the passage time), the exit information (the exit toll booth number and the passage time), and the calculated usage fee are associated.

Next, the security communication API 212 generates encrypted information (the “bill information D4 (FIG. 8)”) in which the account information D1 and the fee information D3 are encrypted using the encryption key information of the service provider P incorporated in the API in advance (step S22).

At this time, as shown in FIG. 5, the security communication API 212 may be configured to generate the bill information D4 in which the “medium ID” for identifying the medium 11 and “connection information (information indicating a connection destination and a connection method)” for connecting to the information relay device 30 incorporated in the API in advance are encrypted in association with the “account information D1” and the “fee information D3”.

Next, the security communication API 212 performs a process of establishing a connection for transmitting and receiving information to and from the information relay device 30 on the basis of the connection information (the information indicating the connection destination and the connection method) for connecting to the information relay device 30 incorporated in the API in advance (step S23).

Next, when the security communication API 212 establishes a connection with the information relay device 30, the transmission unit 213 transmits the “bill information D4” (the encrypted information) generated by the security communication API 212 to the information relay device 30 (step S24).

Then, in the information relay device 30, the process of paying the usage fee is performed on the basis of the account information D1 included in the bill information D4 and the fee information D3.

Next, the payment information reception unit 214 receives the “payment information D5 (FIG. 9)” indicating whether or not the payment from the payment means (the bank account) identified from the account information D1 of the user has succeeded from the information relay device 30 (step S25).

As shown in FIG. 9, the payment information D5 includes the “account information D1” of the user and a “processing result” indicating whether or not the payment of the usage fee has been completed.

As the processing result, information indicating “payment completion” is input when the payer has paid the usage fee normally and information indicating an “insufficient balance” is input when the balance in the bank account is less than the usage fee and payment has not been made.

Also, the payment information D5 may include the medium ID of the medium 11 possessed by the user so that the user can be easily identified.

The payment information reception unit 214 can ascertain whether the usage fee for the user has been paid normally, or whether the balance of the user is insufficient, with reference to the payment information D5.

Next, the insufficient balance notification unit 215 determines whether or not the balance in the payment means (the bank account) of the user is insufficient (step S26).

When the “processing result” included in the payment information D5 is an “insufficient balance” (step S26: YES), the insufficient balance notification unit 215 notifies the user of “insufficient balance information” indicating that the balance in the payment means (the bank account) of the user is insufficient with respect to the usage fee (step S27). At this time, the insufficient balance notification unit 215 is, for example, a display device that notifies the user of the insufficient balance information through text information, a speaker that notifies the user of the insufficient balance information through audio information, or the like. Also, the insufficient balance notification unit 215 may output the insufficient balance information to the medium 11 via short-range wireless communication and notify the user that the balance is insufficient via the display device or the speaker (not shown) of the medium 11.

On the other hand, when the “processing result” included in the payment information D5 is “payment completion” (step S26: NO), the insufficient balance notification unit 215 determines that the payment of the usage fee from the payment means (the bank account) has been completed normally and therefore ends the toll collection process.

Also, the payment information D5 is encrypted and the insufficient balance notification unit 215 can refer to various types of information included in the payment information D5 by decrypting the payment information D5 using the security communication API 212.

### (Process Flow of Information Relay Device)

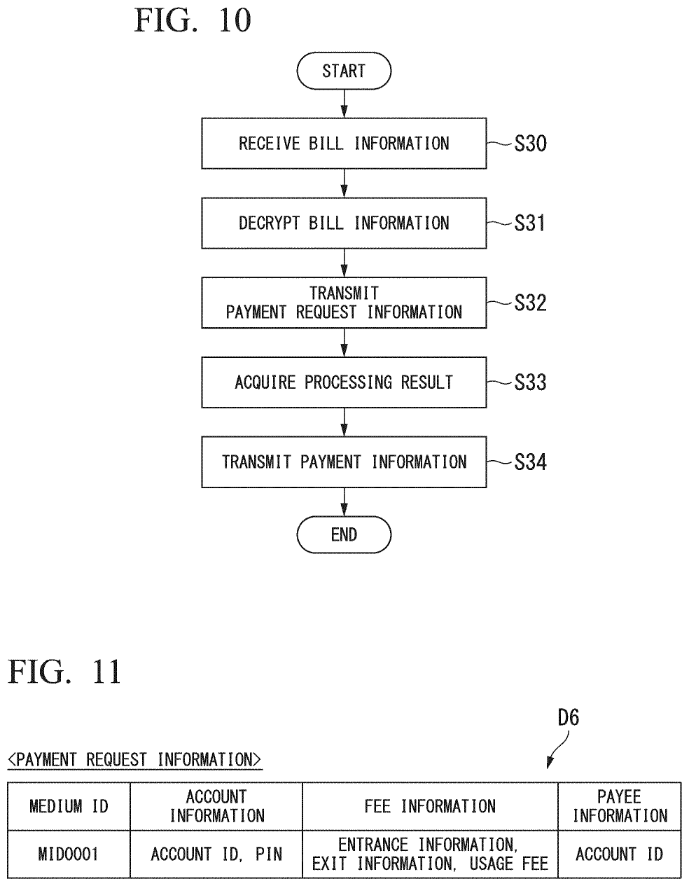

FIG. 10 is a flowchart showing an example of a process in the information relay device according to the first embodiment of the present invention.

FIG. 11 is a diagram showing an example of payment request information according to the first embodiment of the present invention.

Hereinafter, an example of the payment process in the information relay device 30 will be described with reference to FIGS. 10 and 11.

As shown in FIG. 10, first, the reception unit 301 receives the “bill information D4 (FIG. 8)” including the account information D1 and the fee information D3 from the toll collection machine 21 (step S30).

Next, the security communication API 302 decrypts the “bill information D4” using encryption key information of the service provider P incorporated in the API in advance (step S31).

Next, the payment request unit 303 extracts the “account information D1” and the “fee information D3” from the bill information D4 that has been decrypted. The payment request unit 303 transmits the payment request information D6 (FIG. 11) including the “account information D1” and the “fee information D3” to the “payer” (the bank B1) providing the payment means (the bank account in the bank B1) identified from the “account information D1” via the dedicated network (step S32).

As shown in FIG. 11, the payment request information D6 includes the “account information D1” for identifying the payment means of the user, the “fee information D3” including a usage fee, and “payee information” indicating a payee of the usage fee. Also, the payment request information D6 may include information that makes it easy to identify the user, such as a “medium ID.”

Here, it is assumed that the payment request unit 303 adds information indicating a bank account or the like for which a transmission source of the bill information D4 (the toll booth TB or the toll booth center TC) is designated in advance as the “payee information” to the payment request information D6.

When the payment request information D6 is received from the payment request unit 303 of the information relay device 30, the payer executes a process of paying (transmitting) the usage fee indicated by the fee information D3 from the bank account of the user identified from the account information D1 to the bank account of the toll booth TB (or the toll booth center TC).

Next, the processing result acquisition unit 304 acquires a processing result related to the payment of the usage fee by the payer (step S33).

The processing result acquisition unit 304 acquires a processing result indicating “payment completion” when the payer has paid the usage fee from the bank account of the user normally. Also, the processing result acquisition unit 304 acquires a processing result indicating an “insufficient balance” when the payment of the usage fee has failed due to the insufficient balance in the bank account of the user.

Next, the payment information notification unit 305 generates the “payment information D5 (FIG. 9)” including the “processing result” acquired by the processing result acquisition unit 304 and transmits the generated “payment information D5” to the toll collection machine 21 (step S34).

Also, the payment information notification unit 305 may include the “account information D1” and the “medium ID” of the user in the payment information D5 as shown in FIG. 9.

Also, the payment information notification unit 305 encrypts the payment information D5 using the security communication API 302 and transmits the encrypted information to the toll collection machine 21.

The information relay device 30 executes the above-described process every time the bill information D4 is received from the toll booth TB (or the toll booth center TC).

### (Operation and Effect)

As described above, according to the present embodiment, the information relay device 30 provided in the service provider P for performing a process of paying a usage fee of a toll road with respect to a user includes the reception unit 301 configured to receive encrypted information (medium information D2) in which the account information D1 recorded in the medium 11 provided to the user and used to identify a payment means of the user and the fee information D3 including the usage fee for the user calculated in a toll booth TB on the toll road are encrypted; the security communication API 302 provided from the service provider P and configured to decrypt the encrypted information (the medium information D2); and the payment request unit 303 configured to transmit the payment request information D6 including the account information D1 decrypted from the encrypted information (the medium information D2) and the fee information D3 to a payer who provides the payment means identified from the account information D1.

Thereby, the information relay device 30 can appropriately transmit a payment request to each of the payers providing the payment means on the basis of the account information D1 even if a different payment means (for example, a bank account, a credit card, an SNS, or the like) is designated for each user. Thereby, the information relay device 30 can provide the user with a payment service using various types of payment means as well as a credit card.

Also, in the present embodiment, the payer may be a bank and the payment means may be a bank account.

Because high-level security is required for a network for accessing a bank account, a conventional system does not have a mechanism for performing payment by making a direct connection from a toll booth on the toll road to the bank account. However, as described above, the information relay device 30 for performing encryption and decryption by the security communication API 302 can relay information between the toll booth TB and the bank and thus issue a payment request for the usage fee of the toll road to the bank that is the payer without lowering the security level of the network for accessing the bank account. Thereby, the information relay device 30 can provide the user of the toll road with a payment service for immediately paying a usage fee from the bank account of the user.

Also, the information relay device 30 further includes the payment information notification unit 305 configured to notify that a balance is insufficient when the balance in the payment means is less than the usage fee.

Thereby, the information relay device 30 can immediately notify the user that the balance in the payment means (for example, a bank account) is insufficient.

Also, according to the present embodiment, the toll collection machine 21 includes the reception unit 210 configured to receive encrypted information (medium information D2) in which the account information D1 recorded in the medium 11 provided to a user and used to identify a payment means of the user is encrypted; the fee information generation unit 211 configured to generate the fee information D3 including a usage fee according to a use form of a toll road for the user; the security communication unit 212 provided from the service provider P and configured to generate encrypted information (the bill information D4) in which the account information D1 and the fee information D3 are encrypted; and the transmission unit 213 configured to transmit the encrypted information (the bill information D4) to the service provider P.

Thereby, the toll collection machine 21 can request payment according to the account information D1 by transmitting the account information D1 and the fee information D3 to the service provider P even if a different payment means is designated for each user. Thereby, the toll collection machine 21 is not limited to a credit card and can be compatible with a payment service using various types of payment means.

Also, the security communication API 212 is an API provided from the service provider P and performs a process of establishing a connection for transmitting and receiving information to and from the information relay device 30 on the basis of connection information (information indicating a connection destination and a connection method) for connecting to the information relay device 30 incorporated in the API in advance.

As described above, the connection information for connecting to the information relay device 30 can be incorporated in the toll collection machine 21 in a state in which the connection information is secretly kept within the API without being disclosed to the public. Thereby, the toll collection machine 21 and the information relay device 30 can be connected while maintaining the security level required by the payer (the bank).

### Second Embodiment

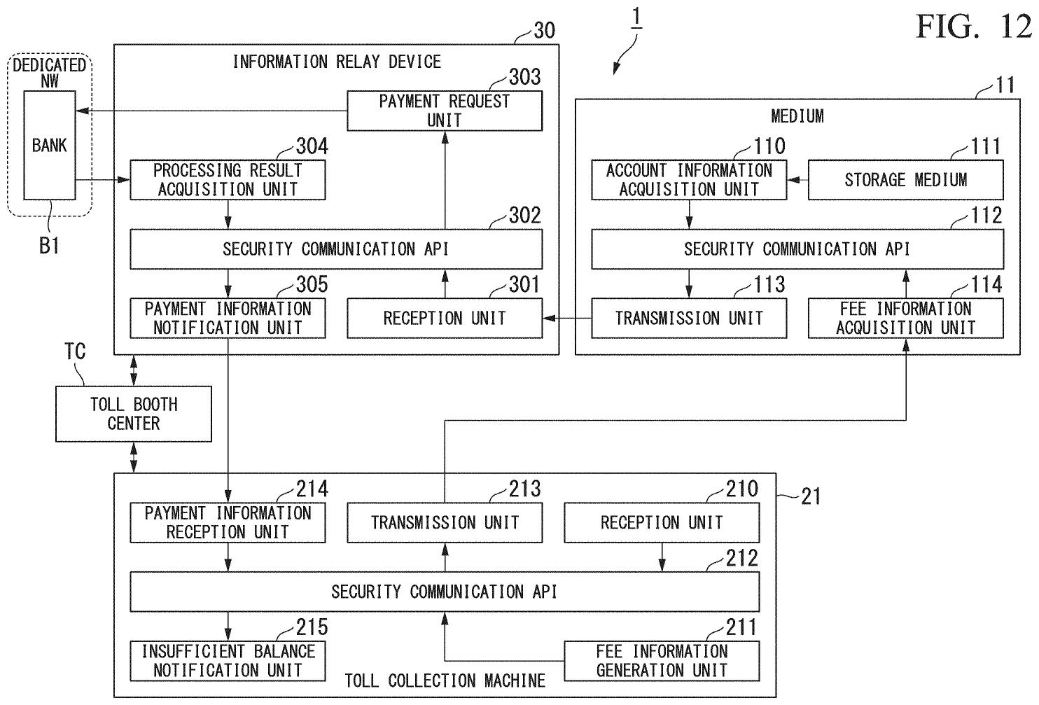

Next, a toll collection system 1 according to a second embodiment of the present invention will be described with reference to FIG. 12.

Components common to the first embodiment are denoted by the same reference signs and the detailed description thereof will be omitted.

In the present embodiment, an aspect in which a medium 11 possessed by a user acquires fee information D3 from a toll collection machine 21 installed in a toll booth TB and transmits bill information D4 used for the payment of a usage fee to an information relay device 30 will be described. Also, the medium 11 according to the present embodiment is a portable terminal (a smartphone, a tablet, or the like), a computer, or the like provided to the user and is connected to the information relay device 30 via a network such as the Internet.

FIG. 12 is a diagram showing a functional configuration of the toll collection system according to the second embodiment of the present invention.

As shown in FIG. 12, the medium 11 according to the present embodiment includes an account information acquisition unit 110, a storage medium 111, a security communication API 112, a transmission unit 113, and a fee information acquisition unit 114.

Also, because functions of the account information acquisition unit 110 and the storage medium 111 are similar to those of the first embodiment, a description thereof will be omitted.

The fee information acquisition unit 114 acquires the fee information D3 (FIG. 7) including a usage fee for a vehicle A from the toll collection machine 21.

The security communication API 112 generates the encrypted information “bill information D4 (FIG. 8)” in which the “account information D1 (FIG. 4)” acquired by the account information acquisition unit 110 and the “fee information D3 (FIG. 7)” acquired by the fee information acquisition unit 114 are encrypted.

Also, the security communication API 112 performs a process of establishing a connection for transmitting and receiving information to and from the information relay device 30 on the basis of connection information (information indicating a connection destination and a connection method) for connecting to the information relay device 30 incorporated in the API in advance.

When the security communication API 112 establishes a connection with the information relay device 30, the transmission unit 113 transmits the “bill information D4” generated by the security communication API 112 to the information relay device 30.

Also, as shown in FIG. 12, the toll collection machine 21 according to the present embodiment includes a reception unit 210, a fee information generation unit 211, a security communication API 212, a transmission unit 213, a payment information reception unit 214, and an insufficient balance notification unit 215.

Also, because functions of the fee information generation unit 211, the payment information reception unit 214, and the insufficient balance notification unit 215 are similar to those of the first embodiment, the description thereof will be omitted. Also, in the present embodiment, the reception unit 210 may be omitted.

The security communication API 212 generates encrypted information in which the “fee information D3” generated by the fee information generation unit 211 is encrypted.

The transmission unit 213 transmits the “fee information D3” generated by the security communication API 212 to the medium 11.

Also, as shown in FIG. 12, the information relay device 30 according to the present embodiment includes a reception unit 301, a security communication API 302, a payment request unit 303, a processing result acquisition unit 304, and a payment information notification unit 305.

Also, because functions of the security communication API 302, the payment request unit 303, the processing result acquisition unit 304, and the payment information notification unit 305 are similar to those of the first embodiment, a description thereof will be omitted.

The reception unit 301 receives the “bill information D4 (FIG. 8)” including the account information D1 and the fee information D3 from the medium 11.

As described above, according to the present embodiment, the medium 11 provided to a user of a toll road includes the account information acquisition unit 110 configured to acquire the account information D1 prestored in the storage medium 111 and used to identify a payment means of the user; the fee information acquisition unit 114 configured to acquire the fee information D3 including a usage fee for the user calculated in the toll booth TB on the toll road; the security communication API 112 provided from the service provider P and configured to generate encrypted information (the bill information D4) in which the account information D1 and the fee information D3 are encrypted; and the transmission unit 113 configured to transmit the encrypted information (the bill information D4) to the service provider P.

Thereby, the medium can request the service provider P to perform payment according to a payment means desired by the user by transmitting the account information D1 prestored in the storage medium 111 and the fee information D3 acquired from the toll booth TB to the service provider P (the information relay device 30). Thereby, the medium 11 is not limited to a credit card and can be compatible with a payment service using various types of payment means.

### Third Embodiment

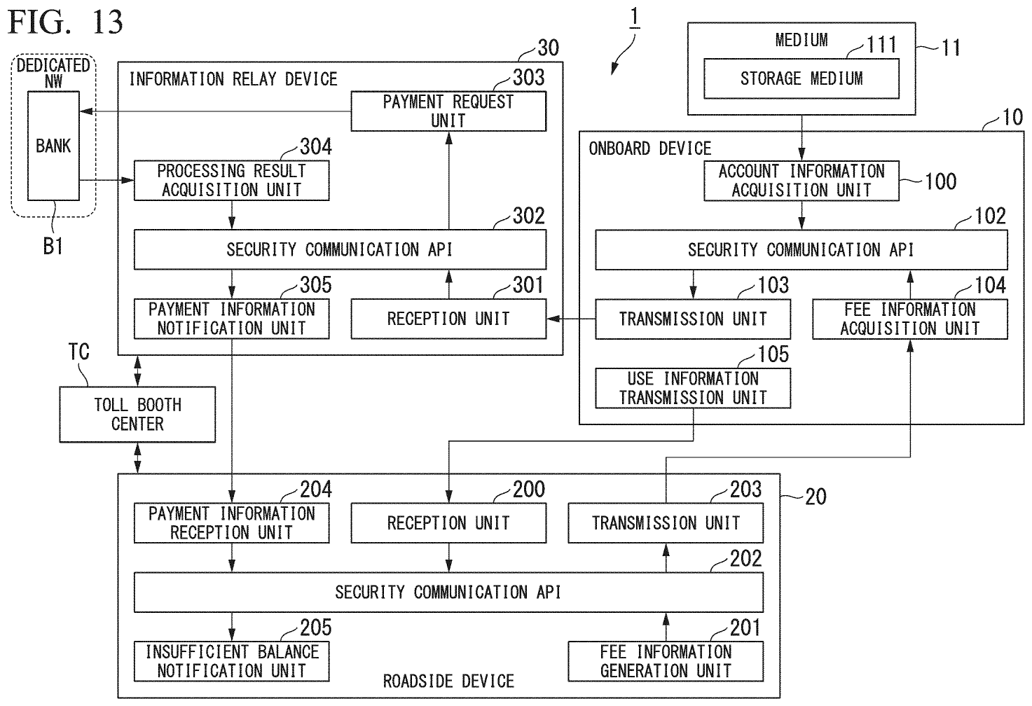

Next, a toll collection system 1 according to a third embodiment of the present invention will be described with reference to FIG. 13.

Components common to the first and second embodiments are denoted by the same reference signs and a detailed description thereof will be omitted.

In the present embodiment, an aspect in which an onboard device 10 mounted in a vehicle A acquires account information D1 from a medium 11, acquires fee information D3 from a roadside device 20 installed in a toll booth TB, and transmits bill information D4 used to pay a usage fee to an information relay device 30 will be described.

FIG. 13 is a diagram showing a functional configuration of the toll collection system according to the third embodiment of the present invention.

As shown in FIG. 13, the onboard device 10 according to the present embodiment includes an account information acquisition unit 100, a security communication API 102, a transmission unit 103, a fee information acquisition unit 104, and a use information transmission unit 105.

When the fee information acquisition unit 104 to be described below has acquired the “fee information D3 (FIG. 7),” the account information acquisition unit 100 acquires the “account information D1 (FIG. 4)” of the user prestored in a storage medium 111 of the medium 11.

Also, the medium 11 according to the present embodiment is, for example, an IC card provided to a user. The fee information acquisition unit 104 acquires the account information D1 from the medium 11 inserted into a card reader (not shown) of the onboard device 10 via a card reader.

The security communication API 102 generates encrypted information (the “bill information D4 (FIG. 8)”) in which the “account information D1 (FIG. 4)” acquired by the account information acquisition unit 100 and the “fee information D3 (FIG. 7)” acquired by the fee information acquisition unit 104 to be described below are encrypted.

Also, the security communication API 102 performs a process of establishing a connection for transmitting and receiving information to and from the information relay device 30 on the basis of connection information (information indicating a connection destination and a connection method) for connecting to the information relay device 30 incorporated in the API in advance.

When the security communication API 102 establishes a connection with the information relay device 30, the transmission unit 103 transmits the “bill information D4” generated by the security communication API 102 to the information relay device 30.

The fee information acquisition unit 104 acquires the fee information D3 (FIG. 7) including a usage fee for a vehicle A from the roadside device 20.

The use information transmission unit 105 transmits use information related to the use of the toll road to the roadside device 20 via wireless communication.

For example, the use information includes various types of information used for calculating a usage fee in the roadside device 20 such as an onboard device ID for identifying the onboard device 10, a vehicle type classification of the vehicle A in which the onboard device 10 is mounted, a discount classification of the vehicle A (for example, information indicating application of a discount for the disabled), entrance information (an entrance toll booth number and a passage time) for identifying an entrance toll booth used by the vehicle. Also, it is assumed that the use information is stored in a storage medium (not shown) of the onboard device 10 or an IC card (such as an ETC card) inserted into the onboard device 10.

Also, as shown in FIG. 13, the roadside device 20 according to the present embodiment includes a reception unit 200, a fee information generation unit 201, a security communication API 202 (a security communication unit), a transmission unit 203, a payment information reception unit 204, and an insufficient balance notification unit 205.

The reception unit 200 receives the use information used for calculating the usage fee from the onboard device 10.

The fee information generation unit 201 generates the “fee information D3 (FIG. 7)” including a usage fee according to a use form of the toll road for the user (the vehicle A).

Specifically, the fee information generation unit 201 acquires the entrance information and the vehicle type classification of the vehicle A included in the use information received from the onboard device 10 and calculates the usage fee according to a usage distance of the vehicle A to the toll booth TB (an exit toll booth) where the roadside device 20 is installed and the vehicle type classification of the vehicle A. At this time, the fee information generation unit 201 may calculate a usage fee according to the discount classification (for example, the discount for the disabled) included in the use information.

The security communication API 202 is an API provided from the service provider P and is a functional unit having a security function of encrypting and decrypting information transmitted and received by the roadside device 20.

The security communication API 202 generates encrypted information in which the “fee information D3” generated by the fee information generation unit 201 is encrypted.

The transmission unit 203 transmits the “fee information D3” generated by the security communication API 202 to the onboard device 10 via wireless communication.

The payment information reception unit 204 and the insufficient balance notification unit 205 have functions similar to those of the payment information reception unit 214 and the insufficient balance notification unit 215 of the toll collection machine 21 according to the first embodiment.

Also, as shown in FIG. 13, the information relay device 30 according to the present embodiment includes a reception unit 301, a security communication API 302, a payment request unit 303, a processing result acquisition unit 304, and a payment information notification unit 305.

Also, because these functions are similar to those of the second embodiment, a description thereof will be omitted.

As described above, according to the present embodiment, the onboard device 10 includes the fee information acquisition unit 104 configured to acquire the fee information D3 including a usage fee of a toll road calculated in the toll booth TB on the toll road; the account information acquisition unit 100 configured to acquire the account information D1 prestored in the storage medium 111 of the medium 11 provided to a user of the toll road and used to identify a payment means of the user when the fee information D3 has been acquired; the security communication API 102 provided from the service provider P and configured to generate encrypted information (the bill information D4) in which the account information D1 and the fee information D3 are encrypted; and the transmission unit 103 configured to transmit the encrypted information (the bill information D4) to the service provider P.

Thereby, the onboard device 10 can request the service provider P to perform payment according to a payment means desired by the user by transmitting the account information D1 prestored in the storage medium 111 of the medium 11 and the fee information D3 acquired from the toll booth to the service provider P. Thereby, the onboard device 10 is not limited to a credit card and can be compatible with a payment service using various types of payment means.

### Fourth Embodiment

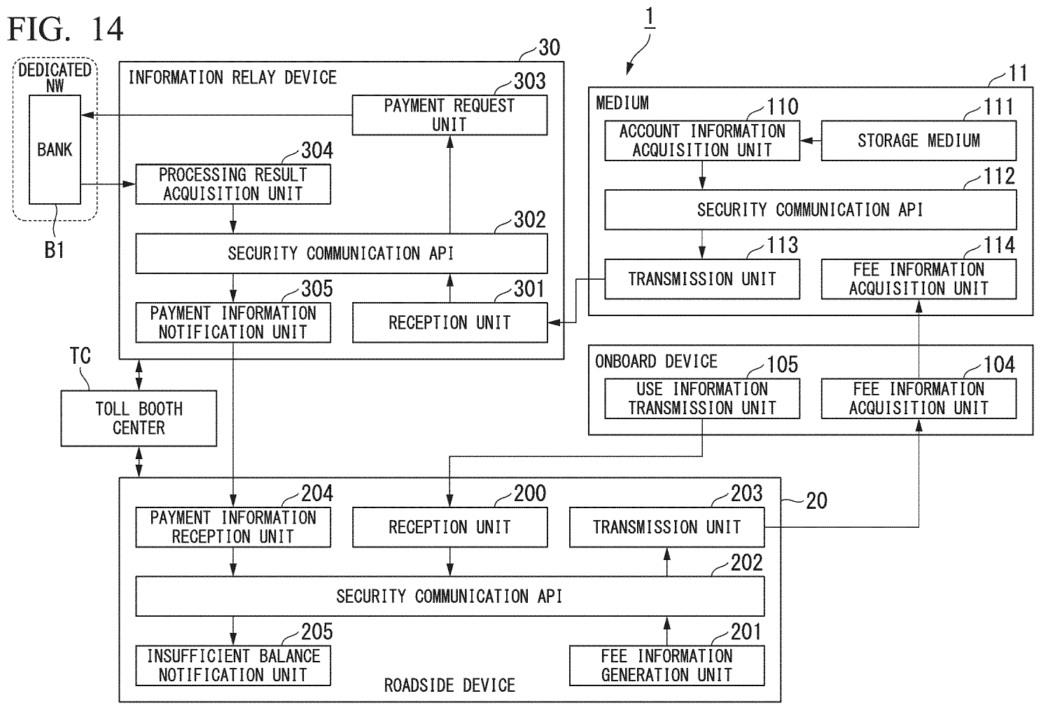

Next, a toll collection system 1 according to a fourth embodiment of the present invention will be described with reference to FIG. 14.

Components common to the first to third embodiments are denoted by the same reference signs and the detailed description thereof will be omitted.

In the present embodiment, an aspect in which a medium 11 possessed by a user acquires fee information D3 from a roadside device 20 installed in a toll booth TB via an onboard device 10 and transmits bill information D4 used for the payment of a usage fee to an information relay device 30 will be described. Also, the medium 11 according to the present embodiment is a portable terminal (a smartphone, a tablet, or the like), a computer, or the like provided to the user and is connected to the information relay device 30 via a network such as the Internet. Also, the medium 11 is connected to the onboard device 10 through wired or wireless communication.

As shown in FIG. 14, the medium 11 according to the present embodiment includes an account information acquisition unit 110, a storage medium 111, a security communication API 112, a transmission unit 113, and a fee information acquisition unit 114.

Also, because functions of the account information acquisition unit 110, the storage medium 111, the security communication API 112, and the transmission unit 113 are similar to those of the second embodiment, the description thereof will be omitted.

Also, the fee information acquisition unit 114 according to the present embodiment is different from that of the second embodiment in that the fee information D3 is acquired from the onboard device 10.

Also, as shown in FIG. 14, the onboard device 10 according to the present embodiment includes a fee information acquisition unit 104 and a use information transmission unit 105.

Also, because a function of the use information transmission unit 105 is similar to that of the third embodiment, a description thereof will be omitted.

Also, the present embodiment is different from the third embodiment in that, when the fee information acquisition unit 114 according to the present embodiment acquires the fee information D3 (FIG. 7) including a usage fee for a vehicle A from the roadside device 20, the fee information D3 is transmitted to the medium 11.

Also, as shown in FIG. 14, the roadside device 20 according to the present embodiment includes a reception unit 200, a fee information generation unit 201, a security communication API 202 (a security communication unit), a transmission unit 203, a payment information reception unit 204, and an insufficient balance notification unit 205.

Also, because these functions are similar to those of the third embodiment, a description thereof will be omitted.

Also, as shown in FIG. 14, the information relay device 30 according to the present embodiment includes a reception unit 301, a security communication API 302, a payment request unit 303, a processing result acquisition unit 304, and a payment information notification unit 305.

Also, because these functions are similar to those of the second embodiment, a description thereof will be omitted.

As described above, in the medium 11 according to the present embodiment, the fee information acquisition unit 114 acquires the fee information D3 by performing wireless communication with the onboard device 10 mounted in the vehicle A.

In such a configuration, the medium 11 according to the present embodiment can also obtain effects similar to those of the second embodiment.

### Fifth Embodiment

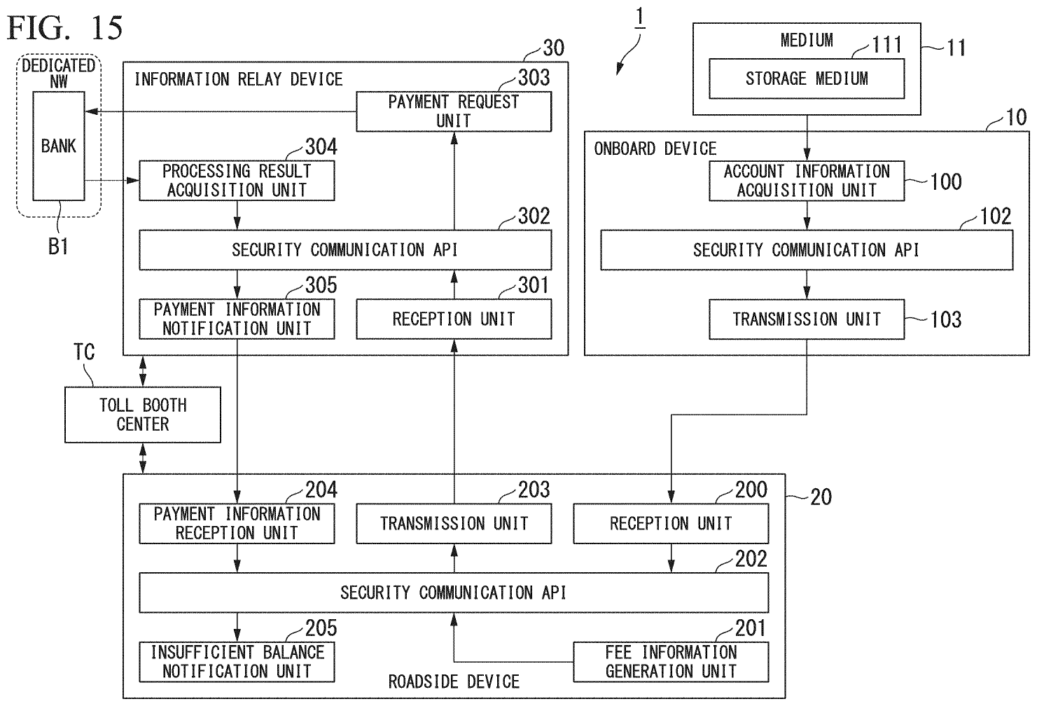

Next, a toll collection system 1 according to a fifth embodiment of the present invention will be described with reference to FIG. 15.

Components common to the first to fourth embodiments are denoted by the same reference signs and the detailed description thereof will be omitted.

In the present embodiment, an aspect in which a roadside device 20 installed in a toll booth TB acquires account information D1 from an onboard device 10 mounted in a vehicle A and transmits bill information D4 used for the payment of a usage fee to an information relay device 30 will be described.

FIG. 15 is a diagram showing a functional configuration of the toll collection system according to the fifth embodiment of the present invention.

As shown in FIG. 15, the onboard device 10 according to the present embodiment includes an account information acquisition unit 100, a security communication API 102, and a transmission unit 103.

Also, because a function of the account information acquisition unit 100 is similar to that of the third embodiment, the description thereof will be omitted.

The security communication API 102 generates encrypted information in which the “account information D1 (FIG. 4)” acquired by the account information acquisition unit 100 is encrypted.

The transmission unit 103 transmits the account information D1 encrypted by the security communication API 102 and use information to the roadside device 20 via wireless communication.

Also, as shown in FIG. 15, the roadside device 20 according to the present embodiment includes a reception unit 200, a fee information generation unit 201, a security communication API 202 (a security communication unit), a transmission unit 203, a payment information reception unit 204 and an insufficient balance notification unit 205.

Also, because functions of the fee information generation unit 201, the payment information reception unit 204, and the insufficient balance notification unit 205 are similar to those of the third embodiment, a description thereof will be omitted.

The reception unit 200 receives the account information D1 and the use information used for calculating the usage fee from the onboard device 10.

The security communication API 202 is an API provided from the service provider P and is a functional unit having a connection function related to a connection to the information relay device 30 provided in the service provider P and a security function of encrypting and decrypting information transmitted and received by the roadside device 20.

The security communication API 202 generates encrypted information (the “bill information D4 (FIG. 8)”) in which the “account information D1” received by the reception unit 200 and the “fee information D3” generated by the fee information generation unit 211 are encrypted.

Also, the security communication API 202 performs a process of establishing a connection for transmitting and receiving information to and from the information relay device 30 on the basis of connection information (information indicating a connection destination and a connection method) for connecting to the information relay device 30 incorporated in the API in advance.

When the security communication API 202 establishes a connection with the information relay device 30, the transmission unit 203 transmits the “bill information D4” generated by the security communication API 202 to the information relay device 30.

Also, although an aspect in which the roadside device 20 directly transmits the bill information D4 to the information relay device 30 via a network such as the Internet will be described in the present embodiment, the present invention is not limited thereto. In another embodiment, the bill information D4 may be transmitted from the roadside device 20 to the information relay device 30 via the toll booth center TC.

Also, as shown in FIG. 15, the information relay device 30 according to the present embodiment includes a reception unit 301, a security communication API 302, a payment request unit 303, a processing result acquisition unit 304, and a payment information notification unit 305.

Also, because functions of the security communication API 302, the payment request unit 303, the processing result acquisition unit 304, and the payment information notification unit 305 are similar to those of the third embodiment, a description thereof will be omitted.

The reception unit 301 receives the “bill information D4 (FIG. 8)” including the account information D1 and the fee information D3 from the roadside device 20.

As described above, according to the present embodiment, the roadside device 20 includes the reception unit 200 configured to receive encrypted information in which the account information D1 recorded in the medium 11 provided to a user and used to identify a payment means of the user is encrypted; the fee information generation unit 201 configured to generate the fee information D3 including a usage fee according to a use form of the toll road for the user; the security communication API 202 provided from the service provider P and configured to generate encrypted information (the bill information D4) in which the account information D1 and the fee information D3 are encrypted; and the transmission unit 203 configured to transmit the encrypted information (the bill information D4) to the service provider P.

Thereby, the roadside device 20 can request payment according to the account information D1 by transmitting the account information D1 and the fee information D3 to the service provider P even if a different payment means is designated for each user. Thereby, the roadside device 20 is not limited to a credit card and can be compatible with a payment service using various types of payment means.

Although embodiments of the present invention have been described in detail above, the present invention is not limited thereto and some design changes are possible without departing from the technical idea of the present invention.

For example, although an aspect in which one piece of account information D1 is stored in the medium 11 has been described in the above-described embodiment, the present invention is not limited thereto. In another embodiment, when the user has a plurality of different types of payment means, the medium 11 may store a plurality of pieces of account information D1. Specifically, it is assumed that the user has bank accounts in a plurality of countries (a country A and a country B). In this case, the medium 11 stores account information D1 associated with the bank account in the country A and account information D1 associated with the bank account in the country B. In this case, the account information acquisition unit 110 of the medium 11 (or the account information acquisition unit 100 of the onboard device 10) may acquire the account information D1 according to the currency of a usage fee included in fee information D3. That is, when the usage fee included in the fee information D3 is input in the currency of the country A (for example, yen), the account information acquisition unit 110 (or the account information 100) acquires the account information D1 associated with the bank account in the country A.

Also, in still another embodiment, the medium 11 (or the onboard device 10) may be configured to acquire a plurality of pieces of account information D1 and transmit the acquired account information D1 to the toll booth TB (the roadside device 20 and the toll collection machine 21) or the information relay device 30. In this case, the payment request unit 303 of the information relay device 30 may be configured to select the account information D1 according to the currency of the usage fee included in the fee information D3 from among the plurality of pieces of account information D1 and make a payment request.

Thereby, the information relay device 30 can automatically select an appropriate payment means according to the usage fee from the plurality of pieces of account information D1 and execute a payment process.

### INDUSTRIAL APPLICABILITY

According to the information relay device, the toll collection machine, the medium, the onboard device, and the roadside device described above, it is possible to provide a payment service in which a plurality of types of payment means are available.

### REFERENCE SIGNS LIST

1 Toll collection system

10 Onboard device

100 Account information acquisition unit

102 Security communication API (security communication unit)

103 Transmission unit

104 Fee information acquisition unit

105 Use information transmission unit

11 Medium

110 Account information acquisition unit

111 Storage medium

112 Security communication API (security communication unit)

113 Transmission unit

114 Fee information acquisition unit

20 Roadside device

200 Reception unit

201 Fee information generation unit

202 Security communication API (security communication unit)

203 Transmission unit

204 Payment information reception unit

205 Insufficient balance notification unit

21 Toll collection machine

210 Reception unit

211 Fee information generation unit

212 Security communication API (security communication unit)

213 Transmission unit

214 Payment information reception unit

215 Insufficient balance notification unit

30 Information relay device

301 Reception unit

302 Security communication API (security communication unit)

303 Payment request unit

304 Processing result acquisition unit

305 Payment information notification unit

1. An information relay device provided in a service provider for performing a process of paying a usage fee of a toll road, the information relay device comprising:
a reception unit configured to receive encrypted information in which account information recorded in a medium provided to a user of the toll road and used to identify a payment means of the user and fee information including the usage fee for the user calculated in a toll booth on the toll road are encrypted;
a security communication unit provided from the service provider and configured to decrypt the encrypted information; and
a payment request unit configured to transmit payment request information including the account information decrypted from the encrypted information and the fee information to a payer who provides the payment means identified from the account information.

2. The information relay device according to claim 1, wherein the payer is a bank and the payment means is a bank account.

3. The information relay device according to claim 1, further comprising a payment information notification unit configured to notify that a balance is insufficient when the balance in the payment means is less than the usage fee.

4. A toll collection machine comprising:
a reception unit configured to receive encrypted information in which account information recorded in a medium provided to a user and used to identify a payment means of the user is encrypted;
a fee information generation unit configured to generate fee information including a usage fee according to a use form of a toll road for the user;
a security communication unit provided from the service provider and configured to generate encrypted information in which the account information and the fee information are encrypted; and
a transmission unit configured to transmit the encrypted information to the service provider.

5. The toll collection machine according to claim 4, further comprising an insufficient balance notification unit configured to notify that a balance is insufficient when the balance in the payment means is less than the usage fee.

6. (canceled)

7. (canceled)

8. (canceled)

9. A roadside device comprising:
a reception unit configured to receive encrypted information in which account information recorded in a medium provided to a user of a toll road and used to identify a payment means of the user is encrypted;
a fee information generation unit configured to generate fee information including a usage fee according to a use form of the toll road for the user;
a security communication unit provided from a service provider and configured to generate encrypted information in which the account information and the fee information are encrypted; and
a transmission unit configured to transmit the encrypted information to the service provider.
